(19) United States
(12) Patent Application Publication
(10) Pub. No.: US 2026/0019341 A1
(43) Pub. Date: Jan. 15, 2026

(54) SYSTEM AND METHOD FOR PERFORMING COVERAGE ANALYSIS IN A NETWORK

(71) Applicant: JIO PLATFORMS LIMITED, Ahmedabad, Gujarat (IN)

(72) Inventors: Aayush BHATNAGAR, Navi Mumbai, Maharashtra (IN); Pradeep Kumar BHATNAGAR, Navi Mumbai, Maharashtra (IN); Sundaresh SANKARAN, Kanjurmarg West, Mumbai, Maharashtra (IN); Haresh B. AMBALIYA, Bhundani, Gujarat (IN); Asha SHARMA, Navi Mumbai, Maharashtra (IN); Premprakash BHAKAR, Thane, Maharashtra (IN); Gunjan MALVIYA; Anjali TRIPATHI, Indore, Madhya Pradesh (IN); Rahul GOYAL, Indore, Madhya Pradesh (IN)

(73) Assignee: JIO PLATFORMS LIMITED, Ahmedabad, Gujarat (IN)

(21) Appl. No.: 18/992,719

(22) PCT Filed: May 28, 2024
(86) PCT No.: PCT/IN2024/050626

§ 371 Date: Jan. 9, 2025

(30) Foreign Application Priority Data
Jun. 28, 2023 (IN) 202321043414

(51) Int. Cl. H04L 41/142; H04B 17/309; H04L 41/16

(52) U.S. Cl. CPC H04L 41/142; H04B 17/309; H04L 41/16

(57) ABSTRACT

The present disclosure provides system (108) and method (200) for daily coverage analysis based on crowd source data. The system includes a data collection module to collect data from users across various locations, a data analysis module to analyze the collected data to identify areas with weak or no signal coverage, and a network optimization module to optimize coverage by deploying additional infrastructure or adjusting antenna configurations based on the analyzed data. The system provides valuable insights into network performance and usage trends, helping network operators plan and prioritize network upgrades and investments more effectively. The system provides proactive identification of areas with weak or no signal coverage.

### FIELD OF DISCLOSURE

The present disclosure relates generally to a field of network optimization technology. In particular, the present disclosure pertains to a system and a method for daily coverage analysis based on crowd source data in telecom network. By collecting data from users across various locations, network operators can identify areas with weak or no signal, enabling them to optimize coverage by deploying additional infrastructure or adjusting antenna configurations.

### DEFINITIONS

As used in the present disclosure, the following terms are generally intended to have the meaning as set forth below, except to the extent that the context in which they are used to indicate otherwise.

The expression ‘thematic map’ used hereinafter in the specification refers to a map that contains one or more thematic layers.

These definitions are in addition to those expressed in the art.

A grid represents a plurality of areas covered by a network.

Noisy data points are a data set that contains extra meaningless data. Almost all data sets will contain a certain amount of unwanted noise. Noisy data can be filtered and processed into a higher quality data set.

### BACKGROUND OF DISCLOSURE

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

The telecommunications industry has undergone significant changes in recent years, with the rapid growth of mobile devices and the increasing demand for high-speed data services. This growth has placed significant pressure on network operators to provide reliable and consistent coverage to their customers. However, network coverage is often impacted by various factors such as topography, building materials, and interference from other sources. As a result, network operators often face challenges in providing consistent coverage across all areas.

The fifth-generation (5G) network promises to revolutionize the telecommunications industry by providing faster data speeds, lower latency, and higher network capacity. However, the deployment of 5G networks has also posed significant challenges, particularly in terms of coverage analysis. One of the biggest challenges in 5G network coverage analysis is the limited coverage area. 5G networks operate on high-frequency bands, which have shorter wavelengths and limited range. As a result, 5G networks require more cell sites than 4G networks, making it more challenging to provide consistent coverage across all areas. Another challenge in 5G network coverage analysis is interference from other sources. 5G networks operate on higher frequencies, which are more susceptible to interference from buildings, trees, and other obstacles. This interference can result in inconsistent coverage and poor network performance.

To provide consistent coverage across all areas, 5G networks require greater network densification. This means more cell sites, more antennas, and more infrastructure. However, network densification can be costly and time-consuming, making it challenging for network operators to deploy 5G networks at scale. Unlike 4G networks, there is currently no standardized testing methodology for 5G network coverage analysis. This makes it challenging for network operators to compare network performance across different vendors and technologies.

Further, as of now, 6G and 7G networks are still in the conceptual stage, and there is limited information available about the specific challenges that these networks will face in terms of coverage analysis. However, based on the challenges faced by previous generations of networks, we can anticipate some of the problems that 6G and 7G networks may face in terms of coverage analysis.

Hence, the challenges faced by 6G and 7G networks in terms of coverage analysis are likely to be similar to those faced by previous generations of networks, albeit on a larger scale. Network operators will need to proactively identify areas with weak or no signal coverage and optimize network performance to provide reliable and consistent coverage to their customers.

There is, therefore, a need for a system and a method for daily coverage analysis based on crowd source data in telecom network.

### SUMMARY

In an exemplary embodiment, a method for performing coverage analysis in a network is described. The method comprises determining a grid of cells representing a geographic area covered by a cellular network, and collecting, by a data collection module, data associated with measurements from a plurality of data sources across a grid of cells in the network. The method further comprises obtaining, by a data analysis module, a plurality of network performance metrics from analysis of the collected data. The method comprises enhancing, by a machine learning (ML) module, the plurality of network performance metrics by evaluating trends in the plurality of network performance metrics over a predefined period and filtering network performance metric anomalies. The method includes analyzing, by the data analysis module (122), the plurality of network performance metrics associated with the grid of cells to determine one or more cells of the grid covering portion of areas in the geographic area with a network coverage less than predefined coverage. The method also includes identifying, by the data analysis module (122), a predetermined number of user equipments (UEs) in the determined one or more cells of the grid. The predefined number of user equipment (UE) in the grid is randomly selected from the users who are located within the grid of cells representing the geographic areas covered by the network. The method further includes performing, by the data analysis module (122), a plurality of speed tests for defined time intervals through the identified UEs of the grid to obtain speed test results. The method includes analyzing the speed test results by comparing the speed test results with the plurality of network performance metrics corresponding to the one or more cells of the grid and determining if the speed test results correspond to the one or more cells that lack network coverage in the one or more cells of the grid.

In some embodiments, the method further comprises identifying a cell of the grid having inconsistent signal coverage.

In some embodiment, the method further comprises identifying a cell of the grid based on a network coverage percentage of the cell being proximate to a network coverage percentage median of the grid of cells.

In some embodiment, the method further comprises identifying a cell of the grid having a network coverage percentage less than a predefined threshold. The predefined threshold is a signal strength/power received below which there is no network connectivity.

In some embodiment, the plurality of network performance metrics comprise a reference signal received power (RSRP), a received signal strength indicator (RSSI), a signal to interference and noise ratio (SINR), a reference signal received quality (RSRQ), a channel quality index (CQI), a physical cell identity (PCI), a block error ratio (BLER), and an uplink throughput and a downlink throughput.

In some embodiment, the method further comprises determining, by the data analysis module (120), at least one network performance attribute associated with each cell of the grid of cells based on the enhanced plurality of network performance metrics, the speed test results and the predefined number of UE, the network performance attribute comprises a coverage area, a coverage percentage, a network capacity, a data rate, a latency, a bandwidth, and a network energy usage.

In some embodiment, the method comprises optimizing, by a network optimization module, the one or more serving cells by performing network optimization steps. The network optimization comprises at least one of performing adjustments in antenna configurations, network switching, and infrastructure modification.

In some embodiment, the method comprises generating, by the network optimization module, a work order to perform network optimization.

In some embodiment, the data sources include a plurality of network speed monitoring applications, an operational support system (OSS), a unified data repository (UDR), and a plurality of network functions.

In some embodiment, the method further comprises filtering the network performance anomalies by identifying and filtering network performance metrics that are outliers in the trend.

In some embodiment, the method further comprises evaluating, by the data analysis module, network availability and quality of coverage of the network by analyzing the network performance metrics.

In another exemplary embodiment, a system for performing coverage analysis in a network is described. A data collection module configured to data associated with measurements from a plurality of data sources across a grid of cells in the network. A data analysis module configured to obtain a plurality of network performance metrics from analysis of the collected data. A machine learning (ML) module configured to enhance accuracy of the plurality of network performance metrics by evaluating trends in the plurality of network performance metrics over a predefined period and filtering network performance metric anomalies. The data analysis module configured to perform a plurality of speed tests for every defined time intervals in the grid through a predefined number of user equipment (UE) of the grid to obtain speed test results. The predefined number of user equipment (UE) in the grid is randomly selected from the users who are located within the grid of cells representing the geographic areas covered by the network. The data analysis module configured to analyze the speed test results by correlating the speed test results with the enhanced plurality of network performance metrics and ascertain the enhanced plurality of network performance metrics based on the correlation between the speed test results and the network performance metrics. The data analysis module configured to determine at least one network performance attribute associated with each cell of the grid of cells based on the enhanced plurality of network performance metrics, the speed test results and the predefined number of UE.

In some embodiment, the data analysis module is configured to identify a cell of the grid having inconsistent signal coverage.

In some embodiment, the data analysis module is configured to is configured to identify a cell of the grid based on a network coverage percentage of the cell being proximate to a network coverage percentage median of the grid of cells.

In some embodiment, the data analysis module is configured to identify a cell of the grid having the network coverage percentage less than a predefined threshold. The predefined threshold is a signal strength/power received below which there is no network connectivity.

In some embodiment, the plurality of network performance metrics comprise a reference signal received power (RSRP), a received signal strength indicator (RSSI), a signal to interference and noise ratio (SINR), a reference signal received quality (RSRQ), a channel quality index (CQI), a physical cell identity (PCI), a block error ratio (BLER), and an uplink throughput and a downlink throughput.

In some embodiment, the method further comprises determining, by the data analysis module (120), at least one network performance attribute associated with each cell of the grid of cells based on the enhanced plurality of network performance metrics, the speed test results and the predefined number of UE, the network performance attribute comprises a coverage area, a coverage percentage, a network capacity, a data rate, a latency, a bandwidth, and a network energy usage.

In some embodiment, a network optimization module is configured to optimize the one or more serving cells by performing network optimization steps. The network optimization comprises at least one of performing adjustments in antenna configurations, network switching, and infrastructure modification.

In some embodiment, the network optimization module is configured to generate a work order to perform network optimization.

In some embodiment, the data sources include a plurality of network speed monitoring applications, an operational support system (OSS), a unified data repository (UDR), and a plurality of network functions.

In some embodiment, the ML module is configured to filter the network performance metric anomalies by identifying and filtering network performance metrics that are outliers in the trend.

In some embodiment, the data analysis module is configured to evaluate network availability and quality of coverage of the network by analyzing the network performance metrics.

In some embodiment, the network optimization module configured to generate a work order to optimize the determined one or more serving cells.

### OBJECTS OF THE PRESENT DISCLOSURE

Some of the objects of the present disclosure, which at least one embodiment herein satisfies are as listed herein below.

An object of the present disclosure is to provide a proactive approach to coverage analysis that leverages crowd-sourced data to identify areas with weak or no signal coverage.

An object of the present disclosure is to enable network operators to gain insights into network performance and identify areas that require attention, thereby optimizing coverage by deploying additional infrastructure or adjusting antenna configurations.

An object of the present disclosure is to provide a comprehensive view of network performance across all locations, enabling network operators to proactively identify areas with inconsistent coverage and take immediate action to optimize network performance.

An object of the present disclosure is to enhance the quality of service for end-users by providing consistent coverage across all areas, resulting in a more efficient and cost-effective network.

An object of the present disclosure is to prioritize network upgrades and investments, resulting in a more efficient and cost-effective network.

An object of the present disclosure is to enable network operators to stay ahead of the competition by providing reliable and consistent coverage to their customers.

An object of the present disclosure is to provide a standardized testing methodology for coverage analysis that enables network operators to compare network performance across different vendors and technologies.

An object of the present disclosure is to provide a secure and reliable system that protects against cyber threats and ensures the integrity of network performance data.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components or circuitry commonly used to implement such components.

FIG. 1A illustrates an exemplary network architecture in which or with which embodiments of the present disclosure may be implemented.

FIG. 1B illustrates an exemplary block diagram of a system for performing coverage analysis in a network, in accordance with an embodiment of the present disclosure.

FIG. 2 illustrates an exemplary method for daily coverage analysis based on crowd source data, in accordance with an embodiment of the present disclosure.

FIG. 3 illustrates a flow diagram of a method for performing coverage analysis in a network; and

FIG. 4 illustrates an exemplary computer system in which or with which embodiments of the present invention can be utilized, in accordance with embodiments of the present disclosure.

The foregoing shall be more apparent from the following more detailed description of the disclosure.

### DETAILED DESCRIPTION OF DISCLOSURE

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present disclosure relates generally to network optimization technology. In particular, the present disclosure pertains to a system and a method for daily coverage analysis based on crowd source data in telecom network. The system provides standardized testing methodology for coverage analysis that enables network operators to compare network performance across different vendors and technologies. This network optimization technology is a groundbreaking innovation that aims to address the coverage issues and enhance the overall user experience. It is a proactive approach to network optimization that utilizes advanced algorithms and predictive analytics to identify potential coverage gaps and take immediate action to optimize the network. This technology revolutionizes the way network operators manage their networks by providing real-time insights into network performance and identifying areas that require attention. It enables operators to optimize network capacity, improve network efficiency, and enhance the quality of service for end-users. The network optimization technology also provides a comprehensive view of the network, allowing operators to identify network issues before they impact users. It helps operators to prioritize network upgrades and investments, resulting in a more efficient and cost-effective network.

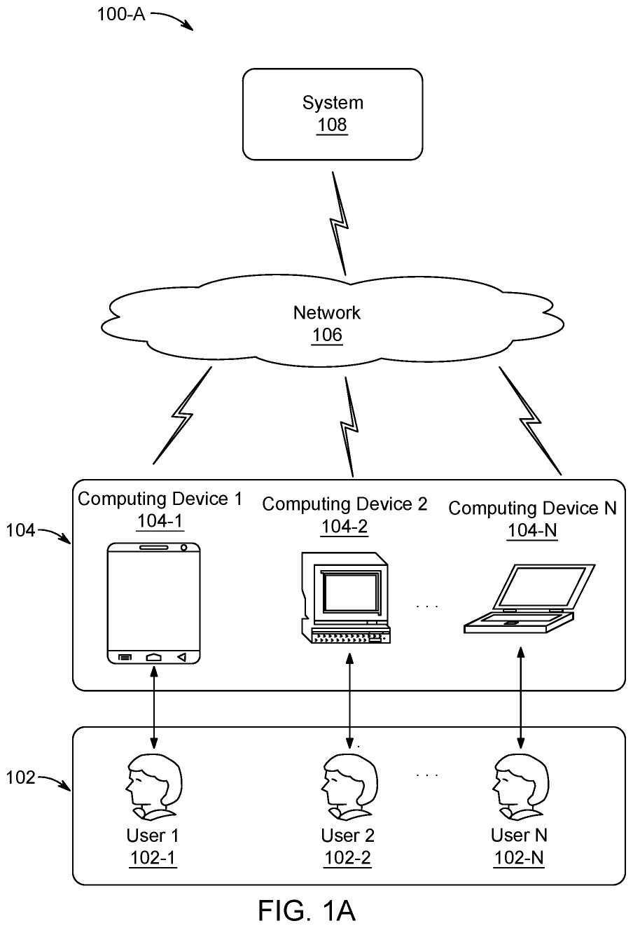

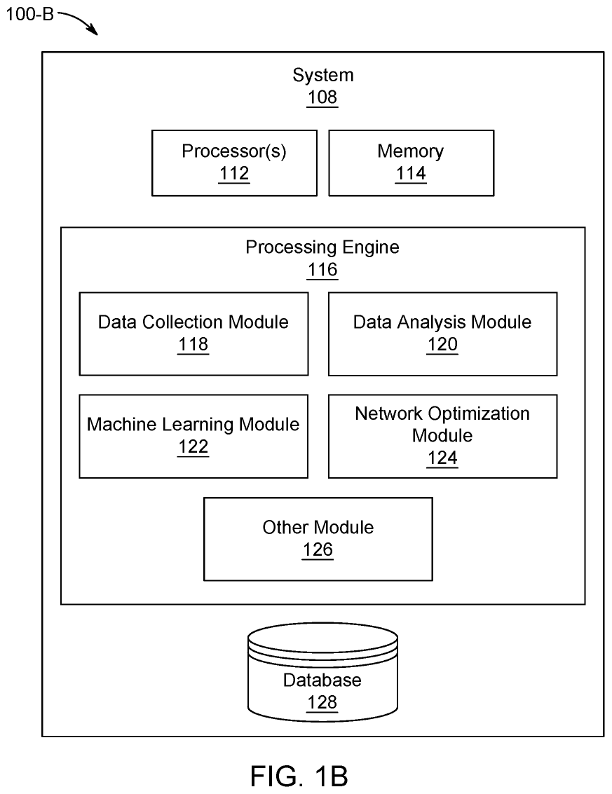

The various embodiments throughout the disclosure will be explained in more detail with reference to FIGS. 1-4.

FIG. 1A illustrates an exemplary network architecture (100-A) in which or with which embodiments of the present disclosure may be implemented.

Referring to FIG. 1A, the network architecture (100-A) may include one or more user equipments (104-1, 104-2 . . . 104-N) associated with one or more users (102-1, 102-2 . . . 102-N) in an environment. A person of ordinary skill in the art will understand that one or more users (102-1, 102-2 . . . 102-N) may be individually referred to as the user (102) and collectively referred to as the users (102). Similarly, a person of ordinary skill in the art will understand that one or more user equipments (104-1, 104-2 . . . 104-N) may be individually referred to as the user equipment (104) and collectively referred to as the user equipment (104). A person of ordinary skill in the art will appreciate that the terms “computing device(s)” and “user equipment” may be used interchangeably throughout the disclosure. Although three user equipments (104) are depicted in FIG. 1A, however any number of the user equipments (104) may be included without departing from the scope of the ongoing description.

In an embodiment, the user equipment (104) may include smart devices operating in a smart environment, for example, an Internet of Things (IoT) system. In such an embodiment, the user equipment (104) may include, but is not limited to, smart phones, smart watches, smart sensors (e.g., mechanical, thermal, electrical, magnetic, etc.), networked appliances, networked peripheral devices, networked lighting system, communication devices, networked vehicle accessories, networked vehicular devices, smart accessories, tablets, smart television (TV), computers, smart security system, smart home system, other devices for monitoring or interacting with or for the users (102) and/or entities, or any combination thereof. A person of ordinary skill in the art will appreciate that the user equipment (104) may include, but is not limited to, intelligent, multi-sensing, network-connected devices, that can integrate seamlessly with each other and/or with a central server or a cloud-computing system or any other device that is network-connected.

In an embodiment, the user equipment (104) may include, but is not limited to, a handheld wireless communication device (e.g., a mobile phone, a smart phone, a phablet device, and so on), a wearable computer device (e.g., a head-mounted display computer device, a head-mounted camera device, a wristwatch computer device, and so on), a Global Positioning System (GPS) device, a laptop computer, a tablet computer, or another type of portable computer, a media playing device, a portable gaming system, and/or any other type of computer device with wireless communication capabilities, and the like. In an embodiment, the user equipment (104) may include, but is not limited to, any electrical, electronic, electro-mechanical, or an equipment, or a combination of one or more of the above devices such as virtual reality (VR) devices, augmented reality (AR) devices, laptop, a general-purpose computer, desktop, personal digital assistant, tablet computer, mainframe computer, or any other computing device, wherein the user equipment (104) may include one or more in-built or externally coupled accessories including, but not limited to, a visual aid device such as a camera, an audio aid, a microphone, a keyboard, and input devices for receiving input from the user (102) or the entity such as touch pad, touch enabled screen, electronic pen, and the like. A person of ordinary skill in the art will appreciate that the user equipment (104) may not be restricted to the mentioned devices and various other devices may be used. Referring to FIG. 1A, the user equipment (104) may communicate with a system (108) through a network (106). In an embodiment, the network (106) may include at least one of a Fifth Generation (5G) network, a Sixth-Generation (6G) network, or the like. The network (106) may enable the user equipment (104) to communicate with other devices in the network architecture (100-A) and/or with the system (108). The network (106) may include a wireless card or some other transceiver connection to facilitate this communication. In another embodiment, the network (106) may be implemented as, or include any of a variety of different communication technologies such as a wide area network (WAN), a local area network (LAN), a wireless network, a mobile network, a Virtual Private Network (VPN), the Internet, the Public Switched Telephone Network (PSTN), or the like.

As illustrated in FIG. 1A, the user equipment (104) is communicatively coupled with a system (108). The user equipment (104) may receive a connection request. The user equipment (104) may send an acknowledgment of connection request to the system (108). Data from a network monitoring application running in the user equipment (104) is sent to the system (108). The system (108) performs a coverage analysis in the network (106).

Although FIG. 1A shows exemplary components of the network architecture (100-A), in other embodiments, the network architecture (100-A) may include fewer components, different components, differently arranged components, or additional functional components than depicted in FIG. 1A. Additionally, or alternatively, one or more components of the network architecture (100-A) may perform functions described as being performed by one or more other components of the network architecture (100-A).

FIG. 1B illustrates an exemplary block diagram (100-B) of the system (108) for daily coverage analysis based on the crowd source data, in accordance with an embodiment of the present disclosure.

Referring to FIG. 1B, where the block diagram (100-B) of the system (108) is shown. The system includes a processor (112) and a memory (114). The system comprises a processing engine (116). The processing engine (116) includes a data collection module (118) configured to collect data from users across various locations; a data analysis module (120) configured to analyze the collected data to identify areas with weak or no signal coverage; and a network optimization module (124) configured to optimize coverage by deploying additional infrastructure or adjusting antenna configurations based on the analyzed data.

In an embodiment, the data collection module (118) is configured to collect data in real-time, enabling network operators to proactively identify areas with inconsistent coverage and take immediate action to optimize network performance. The data collected by the data collection module (118) can come from a variety of sources, including mobile devices, sensors, and other network-connected devices. For example, mobile devices can provide data on signal strength, network speed, and other network performance metrics. Sensors can provide data on environmental factors that may affect network performance, such as temperature, humidity, and air quality. By collecting data in real-time, the data collection module (118) enables network operators to identify areas with weak or no signal coverage as soon as they occur. This enables network operators to take immediate action to optimize network performance, such as deploying additional infrastructure or adjusting antenna configurations.

In an embodiment, the data analysis module (120) is configured to provide a comprehensive view of network performance across all locations, enabling network operators to prioritize network upgrades and investments. The data analysis module (120) uses advanced algorithms. A machine learning (ML) module (122) is configured to analyze the collected data. The machine learning (ML) module (122) may be part of the data analysis module (120). It can identify patterns and trends in the data that may indicate areas with weak or no signal coverage. It can also identify environmental factors that may affect network performance, such as buildings, trees, and other obstacles. The data collection module (108) that collects data from a network speed monitoring application and Passive SDK, which monitor users' network and capture network KPIs based on events.

The data collection from, for example, a speed monitoring app and a Passive SDK may refer to the process of gathering network performance data from users' mobile devices. The speed monitoring app and the Passive SDK are software tools that can be installed on mobile devices, such as smartphones and tablets. They are designed to monitor users' network and capture network KPIs (Key Performance Indicators) based on events. The speed monitoring app is a mobile application that allows users to test the speed and quality of their network connection. It provides real-time data on network performance, such as download and upload speeds, latency, and jitter. This data can be collected by the system and analyzed to gain insights into network performance across various locations. The Passive SDK is a software development kit that can be integrated into mobile applications to capture network performance data. It collects data on network KPIs such as signal strength, network speed, and other network performance metrics. This data can be collected in the background without user intervention and can provide valuable insights into network performance across various locations. By utilizing data collection from the speed monitoring app and the Passive SDK, the system can monitor users' network and capture network KPIs based on events. This data can be used to gain insights into network performance across various locations, identify areas with weak or no signal coverage, and take immediate action to optimize network performance.

In some embodiment, the network optimization module (124) is configured to enhance the quality of service for end-users by providing consistent coverage across all areas. The network optimization module (124) uses the insights gained from the data collection and data analysis modules to deploy additional infrastructure or adjust antenna configurations to enhance network coverage. By doing so, it can ensure that end-users receive consistent coverage across all areas. For example, if the data analysis module (120) identifies that a particular area has consistently poor signal coverage, the network optimization module (124) can deploy additional infrastructure, such as a new cell tower or small cell, to improve signal coverage in that area. Alternatively, it can adjust antenna configurations to optimize network performance. By enhancing the quality of service for end-users, the network optimization module (124) can improve the user experience and increase customer satisfaction. This can result in increased customer loyalty and retention, as well as attracting new customers.

In some embodiment, the data collection module (118) is configured to collect data from a variety of sources, including mobile devices, sensors, and other network-connected devices. Mobile devices, such as smartphones and tablets, are ubiquitous and are often used to access telecom networks. These devices can provide valuable data on signal strength, network speed, and other network performance metrics. By collecting data from these devices, the data collection module (118) can gain insights into network performance across various locations. Sensors are another source of data that can be used to analyze network performance. Sensors can collect data on environmental factors that may affect network performance, such as temperature, humidity, and air quality. By collecting data from sensors, the data collection module (118) can gain insights into how environmental factors affect network performance. Other network-connected devices, such as routers and switches, can also provide data on network performance. By collecting data from these devices, the data collection module (118) can gain a comprehensive view of network performance across all locations. Further, the collected data is then analyzed using the machine learning module (122) to identify and filter out outliers or noisy data points, improving the accuracy of the grid analysis over N number of days.

The machine learning module (122) may use machine learning algorithms that refer to a set of algorithms and statistical models that enable computers to learn and improve from experience without being explicitly programmed. In the context of grid analysis based on crowd source data, machine learning algorithms can be used to identify and filter out outliers or noisy data points, improving the accuracy of the grid analysis over N number of days. Outliers or noisy data points refer to data that does not conform to the expected pattern or trend and can significantly affect the accuracy of the analysis. Machine learning algorithms can be trained to identify these outliers or noisy data points and filter them out from the analysis. By using machine learning algorithms to filter out outliers or noisy data points, the accuracy of the grid analysis can be improved over N number of days. This is because machine learning algorithms can learn from past data and identify patterns and trends that are not immediately apparent to human analysts.

In one embodiment, the system is designed to determine a grid of cells representing the geographic areas covered by the network for poor and good coverage. To determine this grid of cells, the system collects data from various sources, such as speed monitoring app and Passive SDK, which monitor users' network and capture network KPIs based on events. The data collection module (118) collects data from these sources and prepares it for analysis. The data analysis module (120) then analyzes the collected data to identify the areas with poor and good network coverage. The analysis is based on various metrics such as signal strength, network speed, and other network performance metrics. The grid of cells is then divided into two categories—those with poor coverage and those with good coverage—based on the analysis.

In an aspect, the network performance metrics may comprise a reference signal received power (RSRP), a received signal strength indicator (RSSI), a signal to interference and noise ratio (SINR), a reference signal received quality (RSRQ), a channel quality index (CQI), a physical cell identity (PCI), a block error ratio (BLER), and an uplink throughput and a downlink throughput. Network anomalies are anomalies in network behavior deviate from what is normal, standard, or expected. Detection of anomalies in network behavior may include continuous monitoring of a network for unexpected trends or events.

The network performance metric anomalies may comprise poor coverage, low quality, high packet loss, low throughput, high error rate, etc. In current context, the anomalies may include outliers in the trends in trends in the plurality of network performance metrics. The trend may refer to range of values that are expected during a normal functioning of elements in the network. For example, the RSRP range may be between −140 dBm to −44 dBm. Any value beyond this range may be identified ad an outlier or an anomaly. Similarly, the RSSI range may be between −100 dBm to 0 dBm.

In an embodiment, identifying random N users for a grid refers to randomly selecting N users who are located within the grid of cells representing the geographic areas covered by the network. UE associated with the users are identified and then subjected to active speed tests at different time intervals to ascertain the data obtained from machine learning (ML). Active speed tests measure the network performance by simulating the user's activity on the network. These tests can be conducted using various tools and software applications, such as speed test apps. By performing active speed tests on different time intervals, the system can gather more data on network performance and validate the accuracy of the ML algorithm's predictions. The different time intervals may refer to different time periods, such as late in the night (00.00 hours), morning peak hours (8:30 AM to 9:30 AM), etc. Different time intervals may help analyze the speed test at different time periods for a better understanding of network coverage and capacities. Based on the test results and the number of users, the system can calculate the coverage percentage for the grid. In examples, the analyzing the speed test results by comparing the speed test results with the plurality of network performance metrics corresponding to the one or more cells of the grid and determining if the speed test results correspond to the one or more cells that lack network coverage in the one or more cells of the grid. For example, a network performance metric, downlink throughput provided by a UE may be 15 Mbps for a 4G LTE network indicating poor coverage. The speed test using the same UE may show a speed test result of 18 Mbps, which when compared with the downlink throughput, ascertains that the signal coverage is weak for that geographical area covered by the cell in the grid. The coverage percentage represents the percentage of users who are experiencing good network performance within the grid. Based on this percentage, the system can identify the poor grid, which represents the areas with poor network performance.

In an embodiment, the system determines a serving cell for the identified grid. The serving cell refers to the base station or cell tower that provides the strongest signal to a mobile device within a particular geographic area. To determine the serving cell for the identified grid, the system analyzes the data collected from various sources, such as network logs and signal strength measurements, and identifies the cell with the strongest signal within the grid. This cell is considered to be the serving cell for the identified grid. Knowing the serving cell for a particular grid can help network operators identify areas where network coverage may be weak and take steps to optimize network performance and mobile device users understand which cell tower is providing them with the strongest signal, which can be useful when troubleshooting connectivity issues or trying to improve network performance.

In an embodiment, the system also generates a work order to optimize the serving cell. The work order is a document that outlines the tasks that need to be performed to optimize the serving cell. The work order includes details such as the location of the serving cell, the type of equipment required, and the specific tasks that need to be performed to optimize the cell. The work order may include tasks such as adjusting the antenna orientation, replacing faulty equipment, or adding additional equipment to improve network coverage and performance. The work order may also include a timeline for completing the tasks and a budget for the required equipment and labor.

Further, the present disclosure provides a method for daily coverage analysis based on crowd source data in telecom network.

In an aspect of the present invention, performing daily analysis of the network coverage based on crowdsource data involves analyzing and evaluating the availability and quality of network coverage in different areas using data contributed by users. The data contributed by the user is collected from various speed testing application of the user devices. This approach provides insights into the performance and reach of 4G/5G networks and helps the service providers to optimize the network for a particular area.

In order to optimize the network performance in particular area following steps are performed:
Performing a grid analysis based on crowd source data: Determine a grid of cells representing the geographic areas covered by a cellular network for poor and good coverage in the grid.
Collecting data from plurality of data sources: The data is collected from the speed testing app and Passive SDK through which users' network is monitored and network KPIs are captured based on events.
Performing data Analysis: Machine learning algorithms are used to identify and filter out outliers or noisy data points, improving the accuracy of the grid analysis over N number of days.
Identifying a bottom and median of the grid: The bottom of the grid that is cells with the lowest network coverage or signal strength and the median of the grid representing average network performance across the grid.
Performing active speed test: Identifying random N users for the grid and performing the active speed test on different time interval to ascertain the data obtained from the ML.
Calculating result: Based on the test results and number of users, calculate the coverage percentage and accordingly identify the poor grid.
Serving Cell: Determining the serving cell for the identified grid.
Auto generate work order: Generating work order to optimize the serving cell identified in above analysis.

In an aspect of the present invention, data corresponding to a plurality of grids of cells in the network is collected from a plurality of data sources. The data sources comprise plurality of network speed monitoring applications, an operational support system (OSS), a unified data repository (UDR), and a plurality of network functions. A machine learning (ML) technique is applied to the received data to determine a plurality of features. The features comprise a reference signal received power (RSRP), a received signal strength indicator (RSSI) a signal to interference and noise ratio (SINR), a reference signal received quality (RSRQ), a channel quality index (CQI), a physical cell identity (PCI), a block error ratio (BLER), an uplink throughput and a downlink throughput. Attributes associated with each grid from the plurality of grids are identified based on the plurality of determined features to generate a list if grids. The list of grids is generated by arranging each of the identified grids having a value corresponding to the at least one identified attribute in a decreasing order. A bottom grid is identified from the list of grids. The bottom of the grid represents to at least one cell having a lowest value corresponding to the at least one identified attribute. Number of users for the identified bottom grid is identified from the received data. A plurality of speed tests is conducted on different time intervals to generate real time data corresponding to the at least one attribute. A coverage percentage is calculated based on the generated real time data corresponding to at least one attribute, and the defined number of users. Serving cells are determined based on the calculated coverage percentage. The serving cells are optimized by performing a plurality of network optimizations steps. The plurality of network optimizations steps comprises adjustments in antenna configurations, network switching, and infrastructure addition.

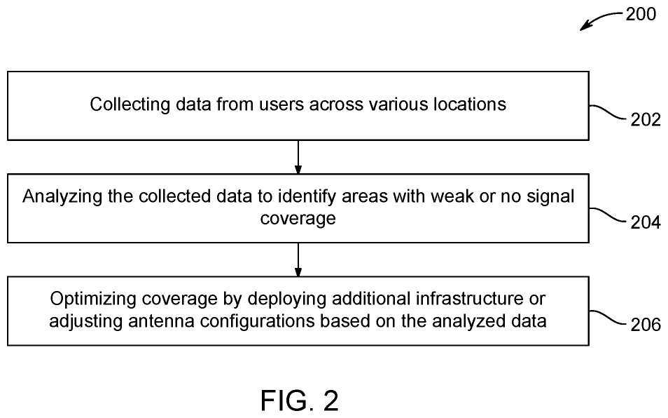

FIG. 2 where schematic flow diagram (200) of steps involved in the method 200 for daily coverage analysis based on crowd source data in telecom network is shown.

Referring to FIG. 2, the flow diagram (200) comprises of following steps:
At step 202, the method 200 includes collecting data from users across various locations.
At step 204, the method 200 includes analyzing the collected data to identify areas with weak or no signal coverage.
At step 206, the method 200 includes optimizing coverage by deploying additional infrastructure or adjusting antenna configurations based on the analyzed data.

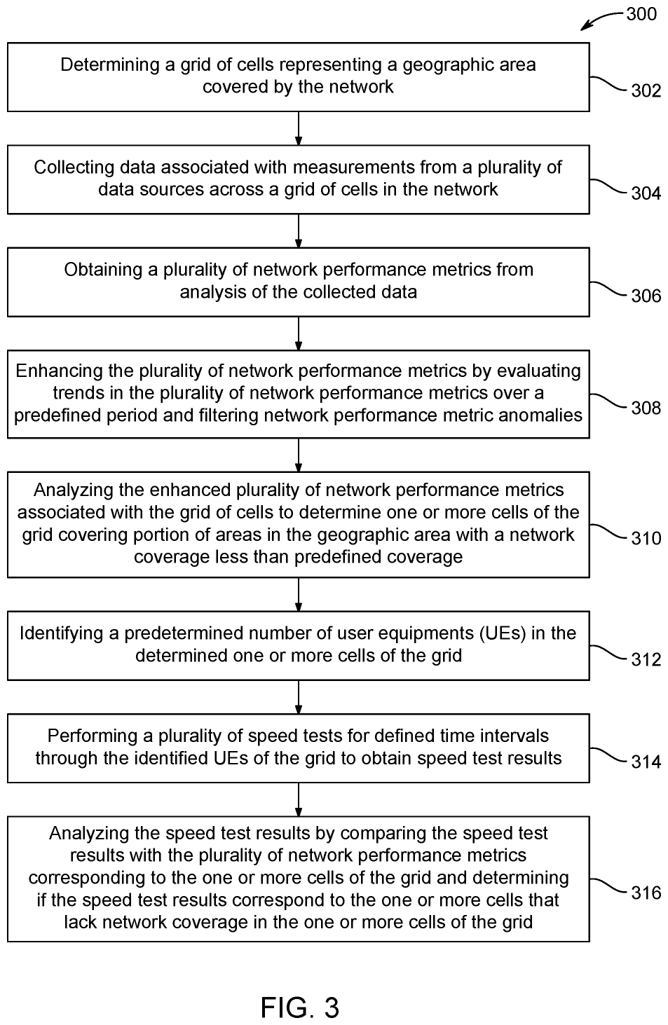

FIG. 3 illustrates a flow diagram (300) for a detailed method for daily coverage analysis based on crowd source data.

Referring to FIG. 3, the flow diagram (300) comprises of following steps:
At step 302, the process begins by determining a grid of cells representing a geographic area covered by the network.
At step 304, the process includes collecting data from various sources, including mobile devices, sensors, and other network-connected devices. Further, the data sources include a plurality of network speed monitoring applications, an operational support system (OSS), a unified data repository (UDR), and a plurality of network functions. This data is collected in real-time and is used to identify areas with weak or no signal coverage.
At step 306, the process includes obtaining, by a data analysis module (120), a plurality of network performance metrics from analysis of the collected data. The collected data is then analyzed using machine learning algorithms to obtain the network performance metrics. The network performance metrics comprise a reference signal received power (RSRP), a received signal strength indicator (RSSI), a signal to interference and noise ratio (SINR), a reference signal received quality (RSRQ), a channel quality index (CQI), a physical cell identity (PCI), a block error ratio (BLER), and an uplink throughput and a downlink throughput.
At step 308, the process includes enhancing the plurality of network performance metrics by evaluating trends in the plurality of network performance metrics over a predefined period and filtering network performance metric anomalies. The machine learning algorithm analyzes the poor pattern of N days to identify areas with inconsistent coverage. In this way, the network performance metric anomalies are filtered by identifying and filtering network performance metrics that are outliers in the trend A bottom and median of a grid is determined. The bottom of grid representing the cells with the lowest network coverage or signal strength (network coverage less than a predefined threshold, for example, <=−100 dBm for RSRP in 4G). The median of a grid representing average network performance across the grid (for example, −80 dBm to −90 dBM for RSRP in 4G network). A predefined number of users is identified in the grid using data sources. The predefined number of user equipment (UE) in the grid is randomly selected from the users who are located within the grid of cells representing the geographic areas covered by the network.
At step 310, the process includes analyzing, by the data analysis module (122), the enhanced plurality of network performance metrics associated with the grid of cells to determine one or more cells of the grid covering portion of areas in the geographic area with a network coverage less than predefined coverage.
At step 312, the process includes identifying, by the data analysis module (122), a predetermined number of user equipments (UEs) in the determined one or more cells of the grid, wherein the predefined number of user equipment (UE) in the grid is randomly selected from the users who are located within the grid of cells representing the geographic areas covered by the network.
At step 314, the process includes performing, by the data analysis module (122), a plurality of speed tests for defined time intervals through the identified UEs of the grid to obtain speed test results.
At step 316, the process includes analyzing the speed test results by comparing the speed test results with the plurality of network performance metrics corresponding to the one or more cells of the grid and determining if the speed test results correspond to the one or more cells that lack network coverage in the one or more cells of the grid.

The system also generates a work order to optimize and improve coverage in the identified grid.

In an exemplary embodiment, a computer system in which or with which embodiments of the present invention can be utilized is disclosed.

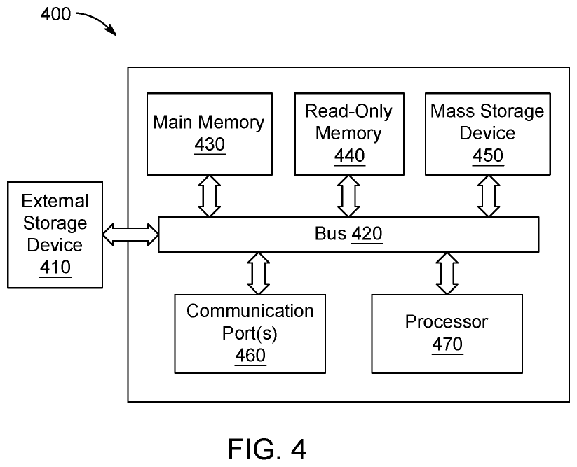

FIG. 4 illustrates an exemplary computer system (400) in which or with which embodiments of the present disclosure may be implemented.

Referring to FIG. 4, the computer system (400) may include an external storage device (410), a bus (420), a main memory (430), a read-only memory (440), a mass storage device (450), communication port(s) (460), and a processor (470). A person skilled in the art will appreciate that the computer system may include more than one processor and communication ports. The processor (470) may include various modules associated with embodiments of the present disclosure. The communication port(s) (460) may be any of an RS-232 port for use with a modem-based dialup connection, a 10/100 Ethernet port, a Gigabit or 10 Gigabit port using copper or fiber, a serial port, a parallel port, or other existing or future ports. The communication port(s) (460) may be chosen depending on a network, such a Local Area Network (LAN), Wide Area Network (WAN), or any network to which the computer system connects.

The main memory (430) may be random access memory (RAM), or any other dynamic storage device commonly known in the art. The read-only memory (440) may be any static storage device(s) e.g., but not limited to, a Programmable Read Only Memory (PROM) chips for storing static information e.g., start-up or Basic Input/Output System (BIOS) instructions for the processor (470). The mass storage device (450) may be any current or future mass storage solution, which can be used to store information and/or instructions. Exemplary mass storage device (450) includes, but is not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g., an array of disks.

The bus (420) communicatively couples the processor (470) with the other memory, storage, and communication blocks. The bus (420) may be, e.g., a Peripheral Component Interconnect (PCI)/PCI Extended (PCI-X) bus, Small Computer System Interface (SCSI), Universal Serial Bus (USB), or the like, for connecting expansion cards, drives, and other subsystems as well as other buses, such a front side bus (FSB), which connects the processor (470) to the computer system.

Optionally, operator and administrative interfaces, e.g., a display, keyboard, joystick, and a cursor control device, may also be coupled to the bus (420) to support direct operator interaction with the computer system. Other operator and administrative interfaces can be provided through network connections connected through the communication port(s) (460). Components described above are meant only to exemplify various possibilities. In no way should the aforementioned exemplary computer system limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter to be implemented merely as illustrative of the disclosure and not as limitation.

### Advantages of the Present Disclosure

The present disclosure provides proactive identification of areas with weak or no signal coverage, as the system collects data from users in real-time, allowing network operators to identify areas with inconsistent coverage and take immediate action to optimize network performance.

The present disclosure provides a comprehensive view of network performance across all locations, enabling network operators to prioritize network upgrades and investments.

The present disclosure optimizes coverage to enhance the quality of service for end-users by providing consistent coverage across all areas.

The present disclosure helps reducing costs by streamlining processes, eliminating waste, and lowering the overall cost of production.

The present disclosure provides a competitive advantage by offering unique features or capabilities that differentiate it from competitors.

The present disclosure promotes sustainability by reducing waste, conserving resources, and minimizing environmental impact.

The present disclosure allows network operators to quickly identify and resolve network issues, reducing downtime and improving overall network reliability.

The present disclosure helps network operators identify areas of high demand and allocate network resources more efficiently, reducing congestion and improving network performance.

The present disclosure shows system's ability to optimize coverage and enhance the quality of service can lead to improved customer satisfaction, which can help reduce churn and increase revenue.

The system provided by the present disclosure can be easily scaled to accommodate growing network demands, making it a flexible and adaptable solution for telecom operators.

The present disclosure provides valuable insights into network performance and usage trends, helping network operators plan and prioritize network upgrades and investments more effectively.

1. A method for performing coverage analysis in a network, the method comprising:
determining a grid of cells representing a geographic area covered by the network;
collecting, by a data collection module, data associated with measurements from a plurality of data sources across the grid of cells in the network;
obtaining, by a data analysis module, a plurality of network performance metrics from analysis of the collected data;
enhancing, by a machine learning (ML) module, the plurality of network performance metrics by evaluating trends in the plurality of network performance metrics over a predefined period and filtering network performance metric anomalies;
analyzing, by the data analysis module, the enhanced plurality of network performance metrics associated with the grid of cells to determine one or more cells of the grid of cells covering a portion of areas in the geographic area with a network coverage less than a predefined coverage;
identifying, by the data analysis module, a predetermined number of user equipments (UEs) in the determined one or more cells of the grid of cells, wherein the predetermined number of UEs in the grid of cells is randomly selected from users who are located within the grid of cells representing the geographic area covered by the network;
performing, by the data analysis module, plurality of speed tests for defined time intervals in the grid of cells through the identified predetermined number of UEs of the grid of cells to obtain speed test results; and
analyzing, by the data analysis module, the speed test results by comparing the speed test results with the enhanced plurality of network performance metrics corresponding to the one or more cells of the grid of cells and determining if the speed test results correspond to the one or more cells that lack network coverage in the one or more cells of the grid of cells.

2. The method as claimed in claim 1, further comprising identifying a cell of the grid of cells having inconsistent signal coverage.

3. The method as claimed in claim 1, further comprising identifying a cell of the grid of cells based on a network coverage percentage of the cell being proximate to a network coverage percentage median of the grid of cells.

4. The method as claimed in claim 1, further comprising identifying a cell of the grid of cells having the network coverage percentage less than a predefined threshold, wherein the predefined threshold is a signal strength/power received below which there is no network connectivity.

5. The method as claimed in claim 1, wherein the plurality of network performance metrics comprise a reference signal received power (RSRP), a received signal strength indicator (RSSI), a signal to interference and noise ratio (SINR), a reference signal received quality (RSRQ), a channel quality index (CQI), a physical cell identity (PCI), a block error ratio (BLER), and an uplink throughput and a downlink throughput, and wherein the plurality of data sources includes a plurality of network speed monitoring applications, an operational support system (OSS), a unified data repository (UDR), and a plurality of network functions.

6. The method as claimed in claim 1, further comprising:
determining, by the data analysis module, at least one network performance attribute associated with each cell of the grid of cells based on the enhanced plurality of network performance metrics, the speed test results and the predetermined number of UEs, wherein the at least one network performance attribute comprises a coverage area, a coverage percentage, a network capacity, a data rate, a latency, a bandwidth, and a network energy usage.

7. The method as claimed in claim 1, further comprising:
optimizing, by a network optimization module, the one or more cells by performing network optimization steps, wherein the network optimization steps comprise at least one of performing adjustments in antenna configurations, a network switching, and an infrastructure modification.

8. The method as claimed in claim 7, further comprising:
generating, by the network optimization module, a work order to perform the network optimization steps.

9. (canceled)

10. The method as claimed in claim 1, wherein the network performance metric anomalies are filtered by identifying and filtering network performance metrics that are outliers in the trends.

11. The method as claimed in claim 1, further comprising:
evaluating, by the data analysis module, a network availability and a quality of coverage of the network by analyzing the plurality of network performance metrics.

12. A system for performing coverage analysis in a network comprising:
a data collection module configured to collect data associated with measurements from a plurality of data sources across a grid of cells in the network;
a data analysis module configured to obtain a plurality of network performance metrics from analysis of the collected data;
a machine learning (ML) module configured to enhance the plurality of network performance metrics by evaluating trends in the plurality of network performance metrics over a predefined period and filtering network performance metric anomalies;
the data analysis module configured to:
analyze the enhanced plurality of network performance metrics associated with the grid of cells to determine one or more cells of the grid of cells covering a portion of areas in the geographic area with a network coverage less than a predefined coverage;
identify a predetermined number of user equipments (UEs) in the determined one or more cells of the grid of cells, wherein the predetermined number of UEs in the grid of cells is randomly selected from users who are located within the grid of cells representing the geographic area covered by the network;
perform a plurality of speed tests for defined time intervals in the grid of cells through the identified predetermined number of UEs of the grid of cells to obtain speed test results;
analyze the speed test results by comparing the speed test results with the enhanced plurality of network performance metrics corresponding to the one or more cells of the grid of cells and determining if the speed test results correspond to the one or more cells that lack network coverage in the one or more cells of the grid of cells.

13. The system as claimed in claim 12, wherein the data analysis module is configured to identify a cell of the grid of cells having inconsistent signal coverage.

14. The system as claimed in claim 12, wherein the data analysis module is configured to identify a cell of the grid of cells based on a network coverage percentage of the cell being proximate to a network coverage percentage median of the grid of cells.

15. The system claimed as in claim 12, wherein the data analysis module is configured to identify a cell of the grid of cells having the network coverage percentage less than a predefined threshold, wherein the predefined threshold is a signal strength/power received below which there is no network connectivity.

16. (canceled)

17. The system as claimed in claim 12, wherein the data analysis module is configured to determine at least one network performance attribute associated with each cell of the grid of cells based on the enhanced plurality of network performance metrics, the speed test results, and the predetermined number of UEs, and wherein the at least one network performance attribute comprises a coverage area, a coverage percentage, a network capacity, a data rate, a latency, a bandwidth, and a network energy usage.

18. The system as claimed in claim 12, wherein a network optimization module is configured to optimize the one or more cells by performing network optimization steps, wherein the network optimization steps comprise at least one of performing adjustments in antenna configurations, a network switching, and an infrastructure modification.

19. The system as claimed in claim 18, wherein the network optimization module is configured to generate a work order to perform the network optimization steps.

20. (canceled)

21. The system as claimed in claim 12, wherein the ML module is configured to filter the network performance metric anomalies by identifying and filtering network performance metrics that are outliers in the trends.

22. The system as claimed in claim 12, wherein the data analysis module is configured to evaluate a network availability and a quality of coverage of the network by analyzing the plurality of network performance metrics.

23. (canceled)

24. A computer program product comprising a non-transitory computer-readable medium comprising instructions that, when executed by one or more processors, cause the one or more processors to perform a method for performing coverage analysis in a network, the method comprising:
determining a grid of cells representing a geographic area covered by the network;
collecting, by a data collection module, data associated with measurements from a plurality of data sources across the grid of cells in the network;
obtaining, by a data analysis module , a plurality of network performance metrics from analysis of the collected data;
enhancing, by a machine learning (ML) module, the plurality of network performance metrics by evaluating trends in the plurality of network performance metrics over a predefined period and filtering network performance metric anomalies;
analyzing, by the data analysis module, the enhanced plurality of network performance metrics associated with the grid of cells to determine one or more cells of the grid of cells covering a portion of areas in the geographic area with a network coverage less than a predefined coverage;
identifying, by the data analysis module, a predetermined number of user equipments (UEs) in the determined one or more cells of the grid of cells, wherein the predetermined number of UEs in the grid of cells is randomly selected from users who are located within the grid of cells representing the geographic area covered by the network;
performing, by the data analysis module, a plurality of speed tests for defined time intervals through the identified predetermined number of UEs of the grid of cells to obtain speed test results; and
analyzing, by the data analysis module, the speed test results by comparing the speed test results with the plurality of network performance metrics corresponding to the one or more cells of the grid of cells and determining if the speed test results correspond to the one or more cells that lack network coverage in the one or more cells of the grid of cells.

25. (canceled)
